(19) United States
(12) Patent Application Publication
(10) Pub. No.: US 2026/0359412 A1
(43) Pub. Date: Nov. 12, 2026

(54) INFORMATION PROCESSING SYSTEM, MOBILE TERMINAL, AND INFORMATION PROCESSING METHOD

(71) Applicant: NEC Corporation, Tokyo (JP)

(72) Inventors: Masato KITADA, Tokyo (JP); Kensaku SATO, Tokyo (JP); Akito SUGA, Tokyo (JP)

(73) Assignee: NEC Corporation, Tokyo (JP)

(21) Appl. No.: 19/515,845

(22) PCT Filed: Sep. 11, 2023
(86) PCT No.: PCT/JP2023/033079

§ 371 Date: Mar. 3, 2026

(51) Int. Cl. G06F 21/32

(52) U.S. Cl. CPC G06F 21/32

(57) ABSTRACT

An information processing system includes: a first authentication unit that performs first authentication using an echo reverberating inside an ear of a target; a second authentication unit that performs second authentication, which is different from the first authentication, on the target; an authentication result integration unit that outputs an integrated authentication result, which is obtained by integrating a result of the first authentication and a result of the second authentication; and a weight change unit that changes a weight used for integration of the result of the first authentication and the result of the second authentication, based on authentication status information, which is information about at least one of a time, a location, and an environmental condition in which the first authentication and the second authentication are performed. According to such an information processing system, it is possible to appropriately perform the authentication processing on the target.

### TECHNICAL FIELD

The present disclosure relates to technical fields of an information processing system, a mobile terminal, an information processing method, and a recording medium.

### BACKGROUND ART

There is known a technology/technique for performing authentication processing (so-called ear acoustic authentication) on a target, based on based on characteristics of an external auditory canal acquired by utilizing sound reverberation/reflection. For example, Patent Literature 1 discloses that an individual can be identified by comparing a response signal collected by outputting an incident signal to an ear with acoustic characteristics of the ear registered in advance.

### CITATION LIST

### Patent Literature

Patent Literature 1: JP2004-065363A

### SUMMARY

### Technical Problem

It is an example object of the present disclosure to provide an information processing system, a mobile terminal, an information processing method, and a recording medium that aim to improve the technology/technique disclosed in Citation List.

### Solution to Problem

An information processing system according to an example aspect of the present disclosure includes: a first authentication unit that performs first authentication using an echo reverberating inside an ear of a target; a second authentication unit that performs second authentication, which is different from the first authentication, on the target; an authentication result integration unit that outputs an integrated authentication result, which is obtained by integrating a result of the first authentication and a result of the second authentication; and a weight change unit that changes a weight used for integration of the result of the first authentication and the result of the second authentication, based on authentication status information, which is information about at least one of a time, a location, and an environmental condition in which the first authentication and the second authentication are performed.

A mobile terminal according to an example aspect of the present disclosure includes: an authentication result integration unit that outputs an integrated authentication result, which is obtained by integrating a result of first authentication using an echo reverberating inside an ear of a target and a result of second authentication, which is different from the first authentication; and a weight change unit that changes a weight used for integration of the result of the first authentication and the result of the second authentication, based on authentication status information, which is information about at least one of a time, a location, and an environmental condition in which the first authentication and the second authentication are performed.

An information processing method according to an example aspect of the present disclosure is an information processing method that is executed by at least one computer, the information processing method including: performing first authentication using an echo reverberating inside an ear of a target; performing second authentication, which is different from the first authentication, on the target; outputting an integrated authentication result, which is obtained by integrating a result of the first authentication and a result of the second authentication; and changing a weight used for integration of the result of the first authentication and the result of the second authentication, based on authentication status information, which is information about at least one of a time, a location, and an environmental condition in which the first authentication and the second authentication are performed.

A recording medium according to an example aspect of the present disclosure is a recording medium on which a computer program that allows at least one computer to execute an information processing method is recorded, the information processing method including: performing first authentication using an echo reverberating inside an ear of a target; performing second authentication, which is different from the first authentication, on the target; outputting an integrated authentication result, which is obtained by integrating a result of the first authentication and a result of the second authentication; and changing a weight used for integration of the result of the first authentication and the result of the second authentication, based on authentication status information, which is information about at least one of a time, a location, and an environmental condition in which the first authentication and the second authentication are performed.

### BRIEF DESCRIPTION OF DRAWINGS

FIG. 1 is a block diagram illustrating a hardware configuration of a first information processing system.

FIG. 2 is a block diagram illustrating a terminal configuration of the first information processing system.

FIG. 3 is a flowchart illustrating an operation flow of the first information processing system.

FIG. 4 is a block diagram illustrating a terminal configuration of a second information processing system.

FIG. 5 is a flowchart illustrating an operation flow of a third information processing system.

FIG. 6 is a block diagram illustrating a terminal configuration of a fourth information processing system.

FIG. 7 is a block diagram illustrating a terminal configuration of a fifth information processing system.

FIG. 8 is a block diagram illustrating a functional configuration of a mobile terminal.

FIG. 9 is a flowchart illustrating an operation flow of the mobile terminal.

### DESCRIPTION OF EXAMPLE EMBODIMENTS

Hereinafter, an information processing system, a mobile terminal, an information processing method, and a recording medium according to example embodiments will be described with reference to the drawings.

### First Example Embodiment

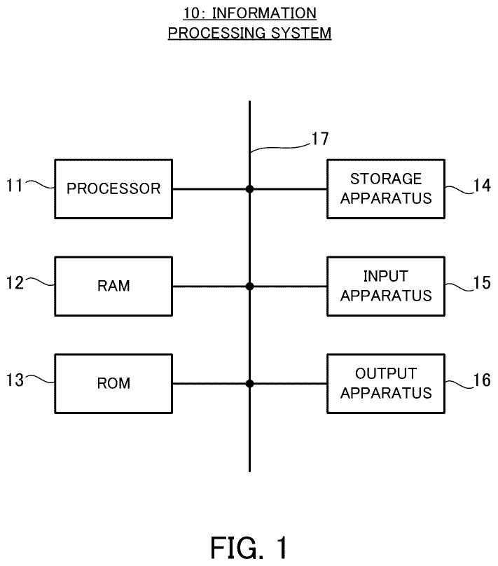

A first information processing system will be described with reference to FIG. 1 to FIG. 3.

### Hardware Configuration

First, a hardware configuration of the first information processing system will be described with reference to FIG. 1. FIG. 1 is a block diagram illustrating the hardware configuration of the first information processing system.

As illustrated in FIG. 1, a first information processing system 10 includes a processor 11, a RAM (Random Access Memory) 12, a ROM (Read-Only Memory) 13, and a storage apparatus 14. The first information processing system 10 may further include an input apparatus 15 and an output apparatus 16. The processor 11, the RAM 12, the ROM 13, the storage apparatus 14, the input apparatus 15, and the output apparatus 16 are connected with each other via a data bus 17. The data bus 17 may also be an interface other than a data bus (e.g., a LAN, a USB, etc.).

The processor 11 reads a computer program. For example, the processor 11 is configured to read a computer program stored in at least one of the RAM 12, the ROM 13, and the storage apparatus 14. Alternatively, the processor 11 may read a computer program stored on a computer-readable recording medium, by using a not-illustrated recording medium reading apparatus. The processor 11 may also acquire (i.e., read) a computer program from a not-illustrated apparatus disposed outside the first information processing system 10 via a network interface. The processor 11 controls the RAM 12, the storage apparatus 14, the input apparatus 15, and the output apparatus 16 by executing the read computer program. Especially in the present example embodiment, when the processor 11 executes the read computer program, a function block for performing processing regarding ear acoustic authentication is realized in the processor 11. That is, the processor 11 may function as a controller that performs each control in the first information processing system 10.

The processor 11 may be configured, for example, as a CPU (Central Processing Unit), a GPU (Graphics Processing Unit), a FPGA (field-programmable gate array), a DSP (Digital Signal Processor), an ASIC (Application Specific Integrated Circuit), or a quantum processor. The processor 11 may be configured by using one of them, or a plurality of them in parallel.

RAM 12 temporarily stores the computer program to be executed by the 11. The RAM 12 temporarily stores data that are temporarily used by the processor 11 when the processor 11 is executing the computer program. The RAM 12 may be, for example, a D-RAM (Dynamic Random Access Memory) or a SRAM (Static Random Access Memory). In addition, another type of volatile memory may be used in place of the RAM 12.

The ROM 13 stores the computer program to be executed by the processor 11. The ROM 13 may also store other fixed data. The ROM 13 may be, for example, a P-ROM (Programmable Read Only Memory) or an EPROM (Erasable Read Only Memory). In addition, another type of nonvolatile memory may be used in place of the ROM 13.

The storage apparatus 14 stores data that are stored by the first information processing system 10 for a long time. The storage apparatus 14 may operate as a transitory storage apparatus of the processor 11. The storage apparatus may store therein the computer program to be executed by the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the first information processing system 10. The input apparatus 15 may include, for example, at least one of a keyboard, a mouse, and a touch panel. The input apparatus 15 may be configured as a part of a smartphone, a tablet terminal, an earphone-type terminal, a watch-type terminal, a HMD (Head Mounted Display) terminal, or the like. The input apparatus 15 may be an apparatus that allows audio input/voice input, including a microphone, for example.

The output apparatus 16 is an apparatus that outputs information about the first information processing system 10 to the outside. For example, the output apparatus 16 may be a display apparatus (e.g., a display) that is configured to display the information about the first information processing system 10. The output apparatus 16 may also be a speaker or the like that is configured to audio-output the information about the first information processing system 10. The output apparatus 16 may be configured as a part of a smartphone, a tablet terminal, an earphone-type terminal, a watch-type terminal, a HMD terminal, or the like.

The first information processing system 10 includes a first terminal and a second terminal, as described later. Each of the components described in FIG. 1 may be configured to be included in at least one of the first terminal and the second terminal provided in the first information processing system 10. Furthermore, a part of the components described in FIG. 1 may be configured to be included in an external apparatus (e.g., an external server, cloud, etc.) that is different from the first terminal and the second terminal.

### Terminal Configuration

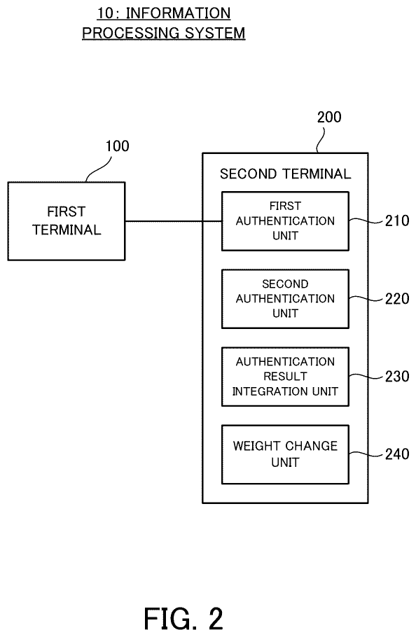

Next, with reference to FIG. 2, a terminal configuration of the first information processing system 10 will be described. FIG. 2 is a block diagram illustrating the terminal configuration of the first information processing system.

In FIG. 2, the first information processing system 10 includes a first terminal 100 and a second terminal 200. The first terminal 100 and the second terminal 200 are connected, for example, via wireless communication, and are configured to transmit and receive information with each other. The first information processing system 10 may be configured to include another terminal (e.g., a third terminal, a fourth terminal, etc.) in addition to the first terminal 100 and the second terminal 200.

The first terminal 100 is configured as an earphone-type hearable terminal. The first terminal 100 may be configured as a terminal worn in one ear. Alternatively, the first terminal 100 may be configured as a terminal worn in both ears. That is, the first terminal 100 may be configured to include a right ear terminal and a left ear terminal. The first terminal 100 is configured to acquire echo information indicating an echo reverberating inside an ear of a target. More specifically, the first terminal 100 transmits a sound wave into the target's ear and acquires an echo signal based on an echo of the transmitted sound wave.

The echo information acquired by the first terminal 100 may be data (e.g., waveform data) representing the echo itself. Alternatively, the echo information may be data representing a feature quantity extracted from the echo. In this case, the first terminal 100 may have a function of extracting the feature quantity from the echo. Alternatively, the second terminal 200 having acquired the echo from the first terminal 100, may have a function of extracting the feature quantity from the echo.

The second terminal 200 is configured as a mobile terminal such as, for example, a smartphone, a tablet terminal, a watch-type terminal, and a HMD terminal, or as a terminal such as a personal computer and a server. The second terminal 200 includes, as processing blocks for realizing its functions, a first authentication unit 210, a second authentication unit 220, an authentication result integration unit 230, and a weight change unit 240.

The first authentication unit 210 is configured to perform first authentication (i.e., ear acoustic authentication) using an echo reverberating inside the target's ear. The first authentication unit 210 performs the first authentication, using the echo information acquired by the first terminal 100. For example, the first authentication unit 210 authenticates whether or not the target is a registered user, by comparing the echo information acquired by the first terminal 100 with pre-registered echo information on the registered user. The first authentication unit 210 may perform the first authentication, using the echo information from one of the right ear and the left ear. Alternatively, the first authentication unit 210 may perform the first authentication, using the echo information from both the ears.

The second authentication unit 220 is configured to perform second authentication that is different from the first authentication performed by the first authentication unit 210. That is, the second authentication unit 220 is configured to perform authentication processing of a different type from the ear acoustic authentication. An authentication method of the second authentication is not particularly limited, but may be, for example, facial recognition, iris recognition, eye-area authentication, fingerprint authentication, and palmprint authentication or the like. Furthermore, the second authentication may be multimodal authentication using multiple modalities. For example, the second authentication may be multimodal authentication using facial information and iris information. The second authentication unit 220 may acquire a modality used for the second authentication, for example, using a camera or the like provided in the second terminal 200. Alternatively, the second authentication unit 220 may acquire the modality used for the second authentication from another terminal (e.g., a not-illustrated third terminal, etc.).

The authentication result integration unit 230 is configured to output an integrated authentication result, which is obtained by integrating/combining a result of the first authentication performed by the first authentication unit 210 and a result of the second authentication performed by the second authentication unit 220. The authentication result integration unit 230 integrates the result of the first authentication and the result of the second authentication, using a predetermined weight. The “weight” here is a parameter for determining a degree of an influence on the integrated authentication result by each of the results of the first and second authentication. For example, in a case where a weight of the first authentication is greater than a weight of the second authentication, the authentication result of the first authentication has a greater influence on the integrated authentication result than the authentication result of the second authentication. Conversely, in a case where the weight of the first authentication is smaller than the weight of the second authentication, the authentication result of the second authentication has a greater influence on the integrated authentication result than the authentication result of the first authentication. More specifically, for example, in a case where the weight of the first authentication is greater than the weight of the second authentication, the integrated authentication result may be considered a success as long as the first authentication is successful, even if the second authentication is failed. Furthermore, in a case where the first authentication is failed, the integrated authentication result may be considered a failure, even if the second authentication is successful.

The integrated authentication result outputted by the authentication result integration unit 230 may be used to perform predetermined processing. For example, the first information processing system 10 may permit the target to operate the first terminal 100 or the second terminal 200 for (e.g., to release an operation lock) in a case where the integrated authentication result indicates a success. Conversely, the first information processing system 10 may not permit the target to operate the first terminal 100 or the second terminal 200 in a case where the integrated authentication result indicates a failure. Alternatively, the integrated authentication result may be outputted to an outside of the first information processing system 10. In this case, an external apparatus may perform processing using the integrated authentication result.

The weight change unit 240 is configured to change the weight used by the authentication result integration unit 230 described above. The weight change unit 240 changes the weight based on authentication status information. The authentication status information pertains to at least one of a time, a location, and an environmental condition in which the first authentication and the second authentication are performed. For example, the weight change unit 240 may utilize a clock function provided in the first terminal 100 or the second terminal 200 to acquire time information serving as the authentication status information. The weight change unit 240 may utilize a GPS (Global Positioning System) function provided in the first terminal 100 or the second terminal 200 to acquire position information serving as the authentication status information. The weight change unit 240 may utilize various sensors provided in the first terminal 100 or the second terminal 200 to acquire brightness information, temperature information, humidity information, barometric pressure information, weather information, acceleration information, or the like serving as the authentication status information. The weight change unit 240 changes the weight used by the authentication result integration unit 230 to enable authentication suitable for the time, location, and environmental condition indicated by the authentication status information.

In a case where the time, location, and environmental condition indicated by the authentication status information are suitable for the first authentication, or unsuitable for the second authentication, the weight change unit 240 may change the weight of the first authentication to be larger, thereby increasing the influence of the first authentication on the integrated authentication result. Conversely, in a case where the time, location, and environmental condition indicated by the authentication status information are unsuitable for the first authentication, or suitable for the second authentication, the weight change unit 240 may change the weight of the first authentication to be smaller, thereby reducing the influence of the first authentication on the integrated authentication result. Furthermore, the weight change unit 240 may change the weight of the second authentication in addition to or instead of changing the weight of the first authentication. That is, the weight change unit 240 may change a relative magnitude relationship between the weight of the first authentication and the weight of the second authentication.

In a case where one of the first and second authentication cannot be performed, the weight change unit 240 may increase the weight of the other authentication. For example, in a case where the first terminal is not worn in the target's ear, the echo information cannot be acquired from the target's ear, and the first authentication cannot be performed. In this case, the weight change unit 240 may reduce the weight of the first authentication or increase the weight of the second authentication. Furthermore, in a case where an image (e.g., a facial image or iris image) used for the second authentication cannot be captured, the second authentication cannot be performed. In this case, the weight change unit 240 may increase the weight of the first authentication or reduce the weight of the second authentication.

Furthermore, the functions of the first authentication unit 210, the second authentication unit 220, the authentication result integration unit 230, and the weight change unit 240 described above may be provided in the first terminal 100. That is, a part or all of the first authentication unit 210, the second authentication unit 220, the authentication result integration unit 230, and the weight change unit 240 may be provided in the first terminal 100. In this case, the first information processing system 10 may be configured without including the second terminal 200.

### Operation Flow

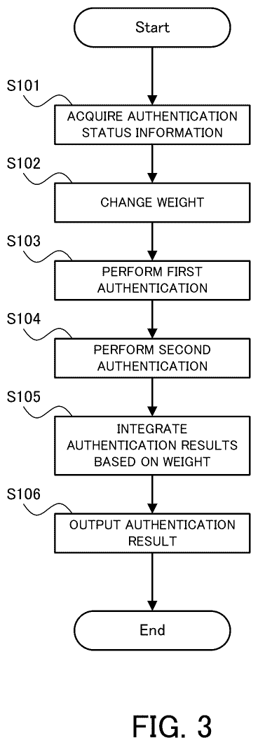

Next, with reference to FIG. 3, an operation flow in the first information processing system 10 will be described. FIG. 3 is a flowchart illustrating the operation flow of the first information processing system.

As illustrated in FIG. 3, when the operation is started in the first information processing system 10, the weight change unit 240 first acquires the authentication status information (Step S101). Then, based on the acquired authentication status information, the weight change unit 240 changes the weight used by the authentication result integration unit 230 (Step S102). Note that in a case where it can be determined that it is not necessary to change the weight based on the authentication status information, the weight change unit 240 may maintain the current weight without changing it.

Then, the first authentication unit 210 performs the first authentication using the echo information (step S103). Furthermore, the second authentication unit 220 performs the second authentication (step S104). In a case where the authentication is failed, the first authentication unit 210 and the second authentication unit 220 may notify the target or the like accordingly. For example, a message such as “Authentication is failed. Please try again from the beginning” may be displayed on a display of the second terminal 200. The step S103 and the step S104 may be performed sequentially in any order, or simultaneously in parallel. That is, the order of performing the first authentication and the second authentication is not particularly limited.

Then, the authentication result integration unit 230 integrates the authentication result of the first authentication and the authentication result of the second authentication, using the weight changed by the weight change unit 240 (step S105). The authentication result integration unit 230 then outputs the integrated authentication result (step S106). Furthermore, until the integrated authentication result is outputted, the first information processing system 10 may output information indicating that the authentication is currently in progress. For example, the first information processing system 10 may display a message such as “Authenticating” on the display of the second terminal 200 or the like. Subsequently, the first authentication processing system 10 may display a message such as “Authentication is successful” or “Authentication is failed” in conjunction with the output of the integrated authentication result.

### Technical Effect

Next, a technical effect obtained by the first information processing system 10 will be described.

As described in FIG. 1 to FIG. 3, in the first information processing system 10, the weight used for the integration of the authentication result of the first authentication and the authentication result of the second authentication, is changed according to the authentication status information. This enables the appropriate execution of the authentication processing for the target, according to the circumstances when the authentication is performed. For example, in a situation in which the first authentication should be prioritized over the second authentication, the weight of the first authentication is increased to produce a more appropriate integrated authentication result. Furthermore, in a situation in which the second authentication should be prioritized over the first authentication, the weight of the first authentication is reduced to produce a more appropriate integrated authentication result. A more specific example of the situation in which the weight should be changed will be described in detail in an example embodiment later.

### Second Example Embodiment

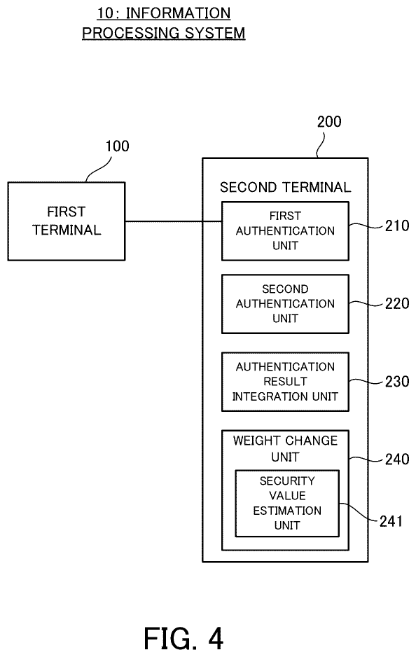

A second information processing system 10 will be described with reference to FIG. 4. Note that the second information processing system 10 partially differs from the first information processing system 10 described above only in its configuration and operation, and may be the same as the first information processing system 10 in the other parts. Therefore, the following description will focus on the parts differing from the first example embodiment, omitting explanations of other overlapping parts as appropriate.

### Terminal Configuration

First, with reference to FIG. 4, a terminal configuration of the second information processing system 10 will be described. FIG. 4 is a block diagram illustrating the terminal configuration of the second information processing system. In FIG. 4, the same reference numerals are used for the same components as those illustrated in FIG. 2.

In FIG. 4, the second information processing system 10 includes the first terminal 100 and the second terminal 200. The second terminal 200 includes, as processing blocks for realizing its functions, the first authentication unit 210, the second authentication unit 220, the authentication result integration unit 230, and the weight change unit 240. Specifically, in the second information processing system 10, the weight change unit 240 in the second terminal 200 includes a security value estimation unit 241.

The security value estimation unit 241 is configured to estimate a security value, based on the authentication status information. The security value indicates a level of security required for the integrated authentication result. The security value may be calculated, for example, as a score out of 100 points or as a two-level value such as “High” and “Low”. The security value estimation unit 241 may estimate a current situation from the authentication status information and may estimate a security value corresponding to the estimated situation. For example, in a case where it can be estimated based on the authentication status information that the target is attempting to perform high-value payment processing using the integrated authentication result, the security value estimation unit 241 may estimate the security value to be higher than the security value when normal payment processing is performed. Whether or not the payment processing is high-value, may be determined, for example, according to a preset threshold. For example, payment processing exceeding 30,000 yen may be treated as the high-value payment processing, while payment processing of 30,000 yen or less may be treated as the normal payment processing. Furthermore, the security value may be set to increase incrementally as a payment amount increases. For example, the security value may be estimated as follows: “1” for payment processing under 1,000 yen, “2” for payment processing between 1,000 yen and 10,000 yen, “3” for payment processing between 10,000 yen and 50,000 yen, “4” for payment processing between 50,000 yen and 100,000 yen, and “5” for payment processing of 100,000 yen or more. Alternatively, in a case where it can be estimated based on the authentication status information that the target is requesting permission to use an apparatus that does not store personal information, the security value estimation unit 241 may estimate the security value to be lower than the security value when permission is requested to use an apparatus that stores personal information. Furthermore, the security value may be made to vary depending on the number and type of personal information stored by the apparatus. For example, the security value may be estimated as “10” when only a name is stored, “15” when a name and address are stored, and “30” when a name, address, and age are stored.

The weight change unit 240 in the second information processing system 10 changes the weight used by the authentication result integration unit 230, based on the security value estimated by the security value estimation unit 241. Specifically, the weight change unit 240 changes the weight of the first authentication to be larger as the security value increases. In other words, the weight change unit 240 changes the weight of the second authentication to be larger as the security value decreases. The weight change unit 240 may calculate the weight from the security value, using a calculation formula prepared in advance. Alternatively, the weight change unit 240 may store respective weight values corresponding to the security values as a map.

### Technical Effect

Next, a technical effect obtained by the second information processing system 10 will be described.

As described in FIG. 4, in the second information processing system 10, the weight used for the integration of the authentication result of the first authentication and the authentication result of the second authentication, is changed based on the security value. This enables the appropriate execution of the authentication processing for the target, according to the level of security required for the integrated authentication result. The ear acoustic authentication offers higher security (e.g., making impersonation or other fraud more difficult), compared with the authentication using other modalities. Therefore, increasing the weight of the first authentication according to the required security level makes it possible to appropriately perform the authentication.

### Third Example Embodiment

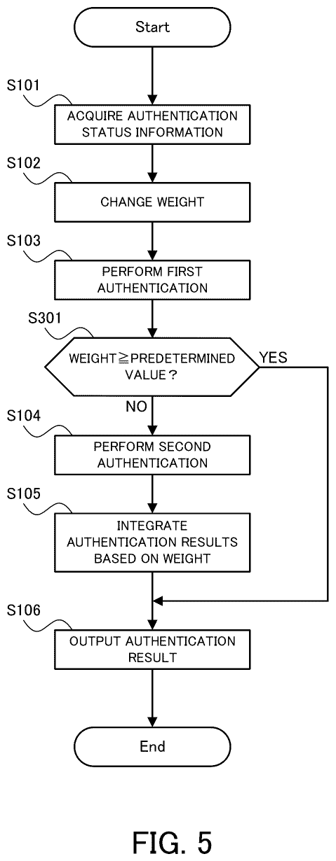

A third information processing system 10 will be described with reference to FIG. 5. Note that the third information processing system 10 partially differs from the first and second information processing systems 10 described above only in its operation, and may be the same as the first and second information processing systems 10 in the other parts. Therefore, the following description details only the parts differing from the already described example embodiments, omitting explanations of other overlapping parts as appropriate.

### Operation Flow

First, with reference to FIG. 5, an operation flow in the third information processing system 10 will be described. FIG. 5 is a flowchart illustrating the operation flow of the third information processing system. Note that in FIG. 5, the same reference numerals are used for the same steps as those illustrated in FIG. 3.

As illustrated in FIG. 5, when the operation is started in the third information processing system 10, the weight change unit 240 first acquires the authentication status information (Step S101). Then, based on the acquired authentication status information, the weight change unit 240 changes the weight used by the authentication result integration unit 230 (Step S102).

Then, the first authentication unit 210 performs the first authentication using the echo information (step S103). Subsequently, the second authentication unit 220 determines whether or not the weight of the first authentication is greater than or equal to a predetermined value (step S301). The predetermined value is a threshold set in advance to determine whether or not to perform the second authentication. The predetermined value is set, for example, as a value at which the weight of the first authentication is greater than or equal to the predetermined value, even in a situation in which the second authentication may not be performed.

In a case where the weight of the first authentication is not greater than or equal to the predetermined value (Step S301: NO), the second authentication unit 220 performs the second authentication (Step S104). Then, the authentication result integration unit 230 integrates the authentication result of the first authentication and the authentication result of the second authentication, using the weight changed by the weight change unit 240 (step S105). The authentication result integration unit 230 then outputs the integrated authentication result (step S106).

On the other hand, in a case where the weight of the first authentication is greater than or equal to the predetermined value (Step S301: YES), the second authentication unit 220 omits the execution of the second authentication. That is, the Step S104 is skipped. In this case, the authentication result of the first authentication may be treated as a final authentication result (i.e., the integrated authentication result). Therefore, the step S105 for integrating the authentication results, may also be skipped. The third information processing system 10 may output information indicating that the execution of the second authentication is omitted. For example, the third information processing system 10 may display a message such as “Second authentication is skipped.” On the other hand, even in a case where the second authentication is omitted, the third information processing system 10 may not display information indicating that. That is, it may intentionally refrain from informing the target that the second authentication processing is skipped.

The second authentication unit 220 may, instead of the aforementioned operation of omitting the second authentication, perform the second authentication in a state where it is always determined to be successful. For example, it may perform the second authentication after setting an authentication threshold for the second authentication to a minimum value. In this case, the second authentication is successful, but the integrated authentication result depends on the authentication result of the first authentication, which has a larger weight. Therefore, the result obtained is essentially the same as the one obtained when the second authentication is omitted.

### Technical Effect

Next, a technical effect obtained by the third information processing system 10 will be described.

As described in FIG. 5, in the third information processing system 10, the execution of the second authentication is mitted in a case where the weight of the first authentication is greater than or equal to the predetermined value. That is, in a situation in which the influence of the authentication result of the first authentication should be strongly reflected in the integrated authentication result, the execution of the second authentication whose influence should be minimized, is omitted. This allows the execution of the second authentication to be omitted without significantly changing the integrated authentication result. Consequently, it is possible to reduce a processing load of the system or reduce a time required for the authentication, without compromising authentication reliability.

### Fourth Example Embodiment

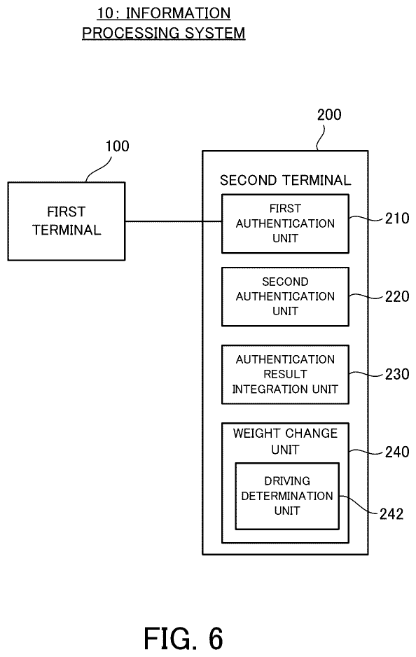

A fourth information processing system 10 will be described with reference to FIG. 6. The fourth information processing system 10 partially differs from the first to third information processing systems 10 described above only in its configuration and operation, and may be the same as the first to third information processing systems 10 in the other parts. Therefore, the following description will focus on the parts differing from the already described example embodiments, omitting explanations of other overlapping parts as appropriate.

### Terminal Configuration

First, with reference to FIG. 6, a terminal configuration of the fourth information processing system 10 will be described. FIG. 6 is a block diagram illustrating the terminal configuration of the fourth information processing system. In FIG. 6, the same reference numerals are used for the same components as those illustrated in FIG. 2.

As illustrated in FIG. 6, the fourth information processing system 10 includes the first terminal 100 and the second terminal 200. The second terminal 200 includes, as processing blocks for realizing its functions, the first authentication unit 210, the second authentication unit 220, the authentication result integration unit 230, and the weight change unit 240. Specifically, in the fourth information processing system 10, the weight change unit 240 in the second terminal 200 includes a driving determination unit 242.

The driving determination unit 242 is configured to determine whether or not the target is driving a moving body, based on the authentication status information. Note that the moving body in this example embodiment encompasses a broad concept including not only general vehicles such as automobiles and bicycles, but also vessels, aircraft, and the like. The authentication status information includes information for determining whether or not the target is driving a moving body. The authentication status information may include, for example, information indicating that the position of the target is the same as the position of the moving body. The authentication status information may include, for example, information indicating that the movement speed of the target has reached a predetermined speed (e.g., the movement speed of the moving body). The fourth information processing system 10 may, for example, acquire the authentication status information in cooperation with a system installed in the moving body driven by the target.

The weight change unit 240 in the fourth information processing system 10 is configured to change the weight, based on a determination result from the driving determination unit 242. Specifically, the weight change unit 240 changes the weight of the first authentication to be larger in a case where the target is driving the moving body, compared with when the target is not driving the moving body. Furthermore, in a case where the target is driving the moving body, the second authentication unit 220 may omit the execution of the second authentication processing, as described in the third example embodiment above. Note that the weight change unit 240 may change the weight, based not only on whether or not the target is driving the moving body, but also on other types of information included in the authentication status information.

### Technical Effect

Next, a technical effect obtained by the fourth information processing system 10 will be described.

As described in FIG. 6, in the fourth information processing system 10, the weight of the first authentication is changed to be larger in a case where the target is driving the moving body. In a case where the target is driving, it is difficult for the target to perform actions other than driving. For instance, it is not easy to capture images while driving to obtain the modality for the second authentication. Conversely, the echo information used for the first authentication can be acquired without any special operation, as long as the first terminal 100 is worn in the ear. Therefore, in a case where the target is driving, increasing the weight of the first authentication, which can be reliably performed even during driving, makes it possible to appropriately perform the authentication.

### Fifth Example Embodiment

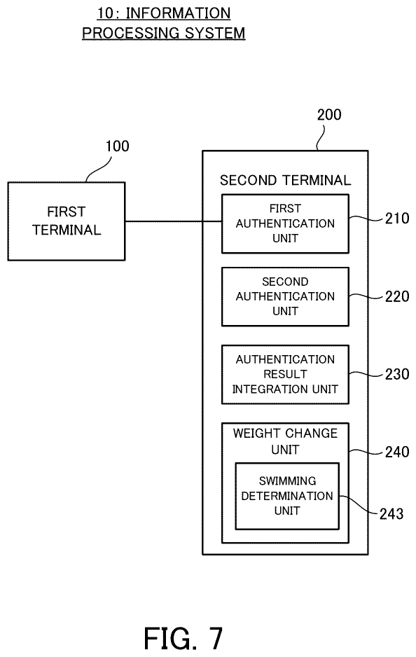

A fifth information processing system 10 will be described with reference to FIG. 7. Note that the fifth information processing system 10 partially differs from the first to fourth information processing systems 10 described above only in its configuration and operation, and may be the same as the first to fourth information processing systems 10 in the other parts. Therefore, the following description will focus on the parts differing from the already described example embodiments, omitting explanations of other overlapping parts as appropriate.

### Terminal Configuration

First, with reference to FIG. 7, a terminal configuration of the fifth information processing system 10 will be described. FIG. 7 is a block diagram illustrating the terminal configuration of the fifth information processing system. In FIG. 7, the same reference numerals are used for the same components as those illustrated in FIG. 2.

As illustrated in FIG. 7, the fifth information processing system 10 includes the first terminal 100 and the second terminal 200. The second terminal 200 includes, as processing blocks for realizing its functions, the first authentication unit 210, the second authentication unit 220, the authentication result integration unit 230, and the weight change unit 240. Specifically, in the fifth information processing system 10, the weight change unit 240 in the second terminal 200 includes a swimming determination unit 243.

The swimming determination unit 243 is configured to determine whether or not the target is swimming, based on the authentication status information. The authentication status information includes information for determining whether or not the target is swimming. The authentication status information may include, for example, information indicating that the position of the target matches the position of a facility where swimming is possible (e.g., an ocean, a pool, etc.). The authentication status information may include, for example, information indicating that water is detected around the target.

The weight change unit 240 in the fifth information processing system 10 is configured to change the weight, based on a determination result from the swimming determination unit 243. Specifically, the weight change unit 240 changes the weight of the first authentication to be larger in a case where the target is swimming, compared with when the target is not swimming. Furthermore, when the target is swimming, the second authentication unit 220 may omit the execution of the second authentication processing, as described in the third example embodiment above. Note that the weight change unit 240 may change the weight, based not only on whether or not the target is swimming, but also on other types of information included in the authentication status information.

### Technical Effect

Next, a technical effect obtained by the fifth information processing system 10 will be described.

As described in FIG. 7, in the fifth information processing system 10, the weight of the first authentication is changed to be larger in a case where the target is swimming. In a case where the target is swimming, it is difficult for the target to perform actions other than swimming. For instance, it is not easy to capture images while swimming to obtain the modality for the second authentication. Conversely, the echo information used for the first authentication can be acquired without any special operation, as long as the first terminal 100 is worn in the ear. Therefore, in a case where the target is swimming, increasing the weight of the first authentication, which can be reliably performed even during swimming, makes it possible to appropriately perform the authentication.

Although the fourth and fifth example embodiments exemplify the configurations for determining the driving and the swimming, similar operations may be performed by determining other states. Specifically, in a case where the target's actions are determined to be restricted (e.g., in a situation in which the target is not able to freely move the hands or face), the weight change unit 240 may increase the weight of the first authentication processing, which can be performed even with the actions restricted.

### Sixth Example Embodiment

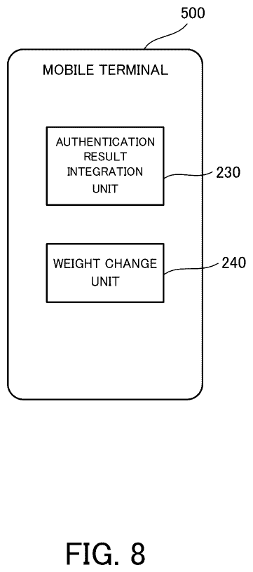

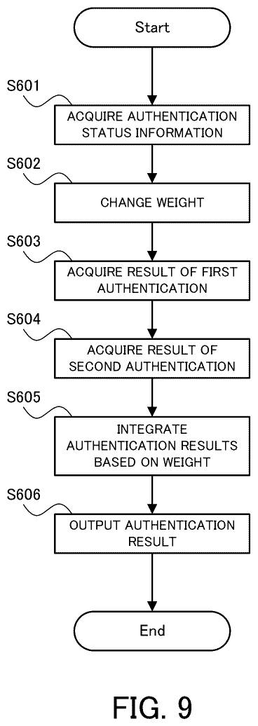

A mobile terminal will be described with reference to FIG. 8 and FIG. 9. A mobile terminal 500 may be configured as one of the terminals included in the first to fifth information processing systems 10 described above, and its configuration and operation may be the same as those described in the first to fifth information processing systems 10. Therefore, the following description will focus on the parts differing from the already described example embodiments, omitting explanations of other overlapping parts as appropriate.

### Terminal Configuration

First, with reference to FIG. 8, a configuration of the mobile terminal will be described. FIG. 8 is a block diagram illustrating a functional configuration of the mobile terminal. Note that in FIG. 8, the same reference numerals are used for the same components as those illustrated in FIG. 2.

In FIG. 8, the mobile terminal 500 is configured as a terminal such as a smartphone, a tablet terminal, a watch-type terminal, and a HMD terminal. The mobile terminal 500 includes, as processing blocks for realizing its functions, the authentication result integration unit 230 and the weight change unit 240.

The authentication result integration unit 230 and the weight change unit 240 may be the same as those provided in the information processing systems 10 described in the first to fifth example embodiments above. Furthermore, the mobile terminal 500 may include at least one of the first authentication unit 210 and the second authentication unit 220. In a case where the mobile terminal 500 includes both the first authentication unit 210 and the second authentication unit 220, the authentication result integration unit 230 may acquire the authentication results from both the first authentication unit 210 and the second authentication unit 220. In a case where the mobile terminal 500 does not include the first authentication unit 210 and the second authentication unit 220, the authentication result integration unit 230 may acquire the authentication results from other terminals that are configured to perform the first authentication and the second authentication.

### Operation Flow

Next, with reference to FIG. 9, an operation flow in the mobile terminal 500 will be described. FIG. 9 is a flowchart illustrating the operation flow of the mobile terminal. In FIG. 9, the same reference numerals are used for the same steps as those illustrated in FIG. 3.

As illustrated in FIG. 9, when the operation is started in the mobile terminal 500, the weight change unit 240 first acquires the authentication status information (Step S601). Then, based on the acquired authentication status information, the weight change unit 240 changes the weight used by the authentication result integration unit 230 (Step S602).

Then, the authentication result integration unit 230 acquires the authentication result of the first authentication using the echo information (Step S603). The authentication result integration unit 230 also acquires the authentication result of the second authentication using information other than the echo information (step S604). Note that the step S603 and the step S604 may be performed sequentially in any order or simultaneously in parallel. That is, the order of acquiring the authentication results of the first authentication and the second authentication is not particularly limited.

Then, the authentication result integration unit 230 integrates the authentication result of the first authentication and the authentication result of the second authentication, using the weight changed by the weight change unit 240 (step S605). Then, the authentication result integration unit 230 outputs the integrated authentication result (step S606).

### Technical Effect

Next, a technical effect obtained by the mobile terminal 500 will be described.

As described in FIG. 8 and FIG. 9, in the mobile terminal 500, the weight used for the integration of the authentication result of the first authentication and the authentication result of the second authentication, is changed according to the authentication status information. This enables the appropriate execution of the authentication processing for the target, according to the circumstances when the authentication is performed. For example, in a situation where the first authentication should be prioritized over the second authentication, the weight of the first authentication is increased to produce a more appropriate integrated authentication result. Furthermore, in a situation where the second authentication should be prioritized over the first authentication, the weight of the first authentication is reduced to produce a more appropriate integrated authentication result.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of Saas (Software as a Service), for example.

### Supplementary Notes

The example embodiments described above may be further described as, but not limited to, the following Supplementary Notes below.

### Supplementary Note 1

An information processing system according to Supplementary Note 1 is an information processing system including: a first authentication unit that performs first authentication using an echo reverberating inside an ear of a target; a second authentication unit that performs second authentication, which is different from the first authentication, on the target; an authentication result integration unit that outputs an integrated authentication result, which is obtained by integrating a result of the first authentication and a result of the second authentication; and a weight change unit that changes a weight used for integration of the result of the first authentication and the result of the second authentication, based on authentication status information, which is information about at least one of a time, a location, and an environmental condition in which the first authentication and the second authentication are performed.

### Supplementary Note 2

An information processing system according to Supplementary Note 2 is the information processing system according to Supplementary Note 1, wherein the weight change unit estimates a security value indicating a level of security required for the integrated authentication result, based on the authentication status information, and changes a weight of the first authentication to be larger as the security value increases.

### Supplementary Note 3

An information processing system according to Supplementary Note 3 is the information processing system according to Supplementary Note 1 or 2, wherein the second authentication unit omits execution of the second authentication in a case where a weight of the first authentication is changed by the weight change unit to be greater than or equal to a predetermined value.

### Supplementary Note 4

An information processing system according to Supplementary Note 4 is the information processing system according to Supplementary Note 1 or 2, wherein the authentication status information includes information indicating whether or not the target is driving a moving body, and the weight change unit changes a weight of the first authentication to be larger in a case where the target is driving, compared with a case where the target is not driving.

### Supplementary Note 5

An information processing system according to Supplementary Note 5 is the information processing system according to Supplementary Note 1 or 2, wherein the authentication status information includes information indicating whether or not the target is swimming, and the weight change unit changes a weight of the first authentication to be larger in a case where the target is swimming, compared with a case where the target is not swimming.

### Supplementary Note 6

A mobile terminal according to Supplementary Note 6 is a mobile terminal including: an authentication result integration unit that outputs an integrated authentication result, which is obtained by integrating a result of first authentication using an echo reverberating inside an ear of a target and a result of second authentication, which is different from the first authentication; and a weight change unit that changes a weight used for integration of the result of the first authentication and the result of the second authentication, based on authentication status information, which is information about at least one of a time, a location, and an environmental condition in which the first authentication and the second authentication are performed.

### Supplementary Note 7

An information processing method according to Supplementary Note 7 is an information processing method that is executed by at least one computer, the information processing method including: performing first authentication using an echo reverberating inside an ear of a target; performing second authentication, which is different from the first authentication, on the target; outputting an integrated authentication result, which is obtained by integrating a result of the first authentication and a result of the second authentication; and changing a weight used for integration of the result of the first authentication and the result of the second authentication, based on authentication status information, which is information about at least one of a time, a location, and an environmental condition in which the first authentication and the second authentication are performed.

### Supplementary Note 8

A recording medium according to Supplementary Note 8 is a recording medium on which a computer program that allows at least one computer to execute an information processing method is recorded, the information processing method including: performing first authentication using an echo reverberating inside an ear of a target; performing second authentication, which is different from the first authentication, on the target; outputting an integrated authentication result, which is obtained by integrating a result of the first authentication and a result of the second authentication; and changing a weight used for integration of the result of the first authentication and the result of the second authentication, based on authentication status information, which is information about at least one of a time, a location, and an environmental condition in which the first authentication and the second authentication are performed.

### Supplementary Note 9

A computer program according to Supplementary Note 9 is a computer program that allows at least one computer to execute an information processing method, the information processing method including: performing first authentication using an echo reverberating inside an ear of a target; performing second authentication, which is different from the first authentication, on the target; outputting an integrated authentication result, which is obtained by integrating a result of the first authentication and a result of the second authentication; and changing a weight used for integration of the result of the first authentication and the result of the second authentication, based on authentication status information, which is information about at least one of a time, a location, and an environmental condition in which the first authentication and the second authentication are performed.

The present disclosure is allowed to be changed, if desired, without departing from the essence or spirit of this disclosure which can be read from the claims and the entire specification. An information processing system, a mobile terminal, an information processing method, and a recording medium with such changes are also intended to be within the technical scope of the present disclosure.

### DESCRIPTION OF REFERENCE CODES

10 Information processing system
11 Processor
100 First terminal
200 Second terminal
210 First authentication unit
220 Second authentication unit
230 Authentication result integration unit
240 Weight change unit
241 Security value estimation unit
242 Driving determination unit
243 Swimming determination unit
500 Mobile terminal

What is claimed is:

1. An information processing system comprising:
at least one memory that is configured to store instructions; and
at least one processor that is configured to execute the instructions to:
perform first authentication using an echo reverberating inside an ear of a target;
perform second authentication, which is different from the first authentication, on the target;
output an integrated authentication result, which is obtained by integrating a result of the first authentication and a result of the second authentication; and
change a weight used for integration of the result of the first authentication and the result of the second authentication, based on authentication status information, which is information about at least one of a time, a location, and an environmental condition in which the first authentication and the second authentication are performed.

2. The information processing system according to Claim 1, wherein the at least one processor is configured to execute the instructions to:
estimate a security value indicating a level of security required for the integrated authentication result, based on the authentication status information; and
change a weight of the first authentication to be larger as the security value increases.

3. The information processing system according to Claim 1, wherein
the at least one processor is configured to execute the instructions to omit execution of the second authentication in a case where a weight of the first authentication is changed to be greater than or equal to a predetermined value.

4. The information processing system according to Claim 1, wherein
the authentication status information includes information indicating whether or not the target is driving a moving body, and
the at least one processor is configured to execute the instructions to change a weight of the first authentication to be larger in a case where the target is driving, compared with a case where the target is not driving.

5. The information processing system according to Claim 1, wherein
the authentication status information includes information indicating whether or not the target is swimming, and
the at least one processor is configured to execute the instructions to change a weight of the first authentication to be larger in a case where the target is swimming, compared with a case where the target is not swimming.

6. A mobile terminal comprising:
at least one memory that is configured to store instructions; and
at least one processor that is configured to execute the instructions to:
output an integrated authentication result, which is obtained by integrating a result of first authentication using an echo reverberating inside an ear of a target and a result of second authentication, which is different from the first authentication; and
change a weight used for integration of the result of the first authentication and the result of the second authentication, based on authentication status information, which is information about at least one of a time, a location, and an environmental condition in which the first authentication and the second authentication are performed.

7. An information processing method that is executed by at least one computer, the information processing method comprising:
performing first authentication using an echo reverberating inside an ear of a target;
performing second authentication, which is different from the first authentication, on the target;
outputting an integrated authentication result, which is obtained by integrating a result of the first authentication and a result of the second authentication; and
changing a weight used for integration of the result of the first authentication and the result of the second authentication, based on authentication status information, which is information about at least one of a time, a location, and an environmental condition in which the first authentication and the second authentication are performed.

8. (Canceled)
